(19) United States
(12) Patent Application Publication
(10) Pub. No.: US 2015/0151633 A1
(43) Pub. Date: Jun. 4, 2015

(54) FUELING DEVICE AND MANUFACTURING METHOD OF FUELING DEVICE

(71) Applicant: TOYODA GOSEI CO., LTD., Kiyosu-shi (JP)

(72) Inventors: Hiroaki KITO, Kiyosu-shi (JP); Yoshinari HIRAMATSU, Kiyosu-shi (JP)

(21) Appl. No.: 14/549,817

(22) Filed: Nov. 21, 2014

(30) Foreign Application Priority Data
Nov. 29, 2013 (JP) 2013-247214

(51) Int. Cl. B60K 15/04; F16K 15/03

(52) U.S. Cl. CPC B60K 15/04; F16K 15/03

(57) ABSTRACT

A fueling device includes a joint section, a neck section, and a retainer having a caulked portion, wherein the neck section includes a neck end portion that includes an open end surface forming an open end of the neck section, a first layer of cylindrical appearance made of a first resin material, and a second layer of cylindrical appearance located on an outer diameter side of the first layer and made of a second resin material having higher impact strength than impact strength of the first resin material, the retainer is attached to the neck section such as to continuously surround at least part of an outer circumferential surface of the neck section, the open end surface and at least part of an inner circumferential surface of the neck section, and the caulked portion is bent radially inward to cause plastic deformation of the second layer.

### CROSS-REFERENCE TO RELATED APPLICATION

The present application claims priority from Japanese application P2013-247214A filed on Nov. 29, 2013, the content of which is hereby incorporated by reference into this application.

### BACKGROUND

1. Technical Field

The present invention relates to a fueling device.

2. Description of the Related Art

A known fueling device for a vehicle has a resin neck section of cylindrical appearance and a metal retainer attached to an end of the neck section to form a filler port. The retainer has cylindrical appearance and has a bent portion provided to have a curved surface convex outward, at an end on the filler port side. The retainer also has a threaded portion formed on an inner circumferential surface of the retainer to be screwed to a fuel cap. A method of injection molding or blow molding a resin with the retainer as an insert has been proposed to form the neck section which the retainer is attached to, as described in, for example, JP 3759981B. This method enables the resin to be placed inside of the bent portion or inside of the threaded portion of undercut shape. This improves the joint performance and the sealing property between the retainer and the neck section.

In order to perform the method of injection molding or blow molding the resin with the retainer as the insert, however, a special mold or a special injection device should be needed and large-scale equipment for manufacture should also be needed. This causes a problem of increasing the manufacturing cost of the fueling device. Other needs over the prior art fueling device include downsizing of the device, improvement of the reliability, resource saving, simplification of manufacture and improvement of usability.

### SUMMARY

In order to solve at least part of the problems described above, the present invention is implemented by any of aspects and embodiments described below.

According to one aspect of the invention, there is provided a fueling device that a fueling nozzle is inserted in and that supplies fuel ejected from the fueling nozzle into a fuel tank. This fueling device comprises a joint section provided to be connected with the fuel tank; a neck section that includes a cylindrical appearance and a multi-layered structure in a radial direction; and a retainer that includes a caulked portion; wherein the neck section further includes: a neck end portion that includes an open end surface forming an open end of the neck section; a first layer of cylindrical appearance made of a first resin material; and a second layer of cylindrical appearance located on an outer diameter side of the first layer and made of a second resin material having higher impact strength than impact strength of the first resin material, the neck end portion is extended from the open end surface along a fuel supply direction from the open end surface toward the joint section that is parallel to a center axis of the neck section, the retainer is attached to the neck section such as to continuously surround at least part of an outer circumferential surface of the neck section, the open end surface and at least part of an inner circumferential surface of the neck section, and the caulked portion is bent radially inward to cause plastic deformation of the second layer.

All the plurality of components included in the aspect of the invention described above are not essential, but some components among the plurality of components may be appropriately changed, omitted or replaced with other components or part of the limitations may be deleted, in order to solve part or all of the problems described above or in order to achieve part or all of the advantageous effects described herein. In order to solve part or all of the problems described above or in order to achieve part or all of the advantageous effects described herein, part or all of the technical features included in one aspect of the invention described above may be combined with part or all of the technical features included in another aspect of the invention described later to provide still another independent aspect of the invention.

The invention may be implemented by any of various aspects other than the fueling device: for example, a filler neck, a vehicle equipped with the fueling device or the filler neck or a manufacturing method of the filler neck.

### BRIEF DESCRIPTION OF DRAWINGS

FIG. 1 is a perspective view illustrating the appearance configuration of a fueling device according to a first embodiment of the invention;

FIG. 2 is an exploded perspective view of the fueling device;

FIG. 3 is a broken perspective view of the fueling device;

FIG. 4 is a diagram illustrating a cross section at an end on an open end surface side of the fueling device;

FIG. 5 is a flowchart showing a manufacturing process of the fueling device;

FIG. 6 is a cross sectional view illustrating a cross section at an end on an open end surface side in a fueling device according to a second embodiment;

FIG. 7 is a cross sectional view illustrating a cross section at an end on an open end surface side in a fueling device according to a third embodiment;

FIG. 8 is a cross sectional view illustrating a cross section at an end on an open end surface side in a fueling device according to a fourth embodiment;

FIG. 9 is a cross sectional view illustrating a cross section at an end on an open end surface side in a fueling device according to a fifth embodiment;

FIG. 10 is a cross sectional view illustrating a cross section at an end on an open end surface side in a fueling device according to a sixth embodiment; and

FIG. 11 is a cross sectional view illustrating the schematic configuration of an open-close device, which a fueling device of a seventh embodiment is applied to.

### DESCRIPTION OF EMBODIMENTS

### A. First Embodiment

### A-1. General Configuration

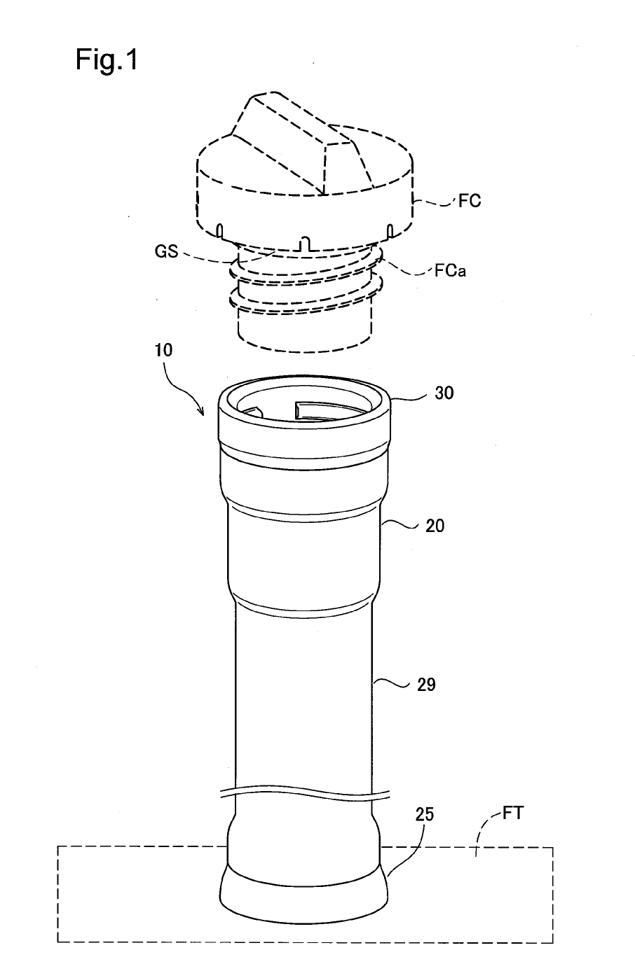

FIG. 1 is a perspective view illustrating the appearance configuration of a fueling device 10 according to a first embodiment of the invention. As illustrated in FIG. 1, the fueling device 10 of cylindrical appearance has a fuel cap FC attached to one open end thereof and is connected to a fuel tank FT at a joint section 25 provided on the other end. The fuel tank FT is mounted, for example, on a vehicle. In the case of fueling using the fueling device 10, the user detaches the fuel cap FC from the fueling device 10 and inserts a fueling nozzle (not shown in FIG. 1) into the fueling device 10 to perform fueling. The fuel ejected from the fueling nozzle (not shown in FIG. 1) flows through a fuel supply passage provided in the fueling device 10 and is fed into the fuel tank FT.

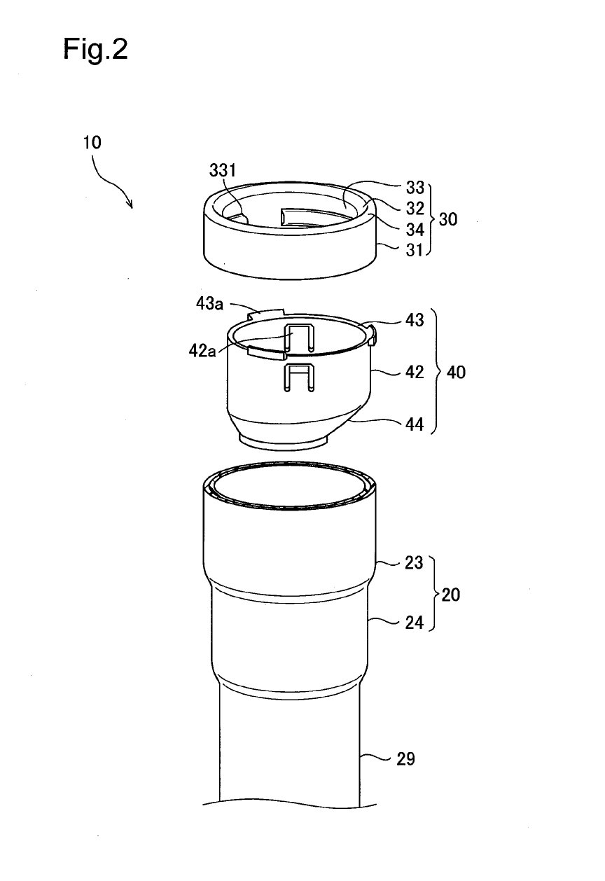

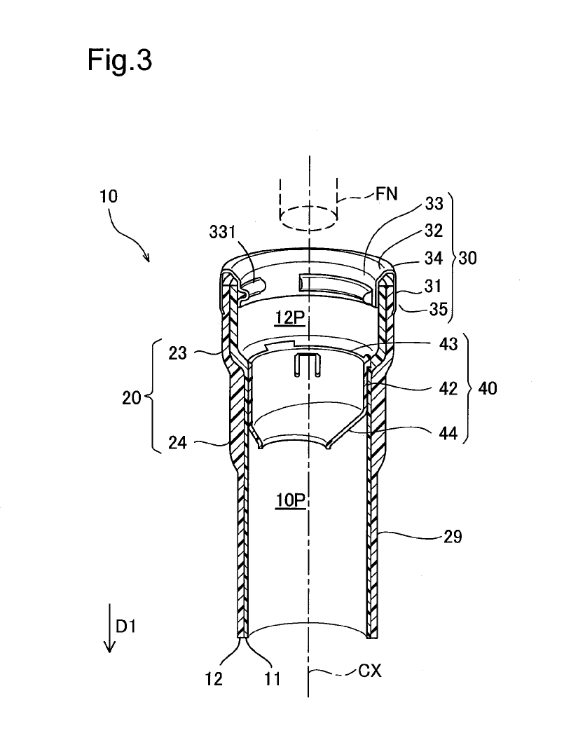

FIG. 2 is an exploded perspective view of the fueling device 10. FIG. 3 is a broken perspective view of the fueling device 10. As illustrated in FIGS. 1 and 2, the fueling device 10 includes a pipe section 29, a neck section 20 and a retainer 30, in addition to the joint section 25 described above. As illustrated in FIGS. 2 and 3, the fueling device 10 includes a nozzle guide member 40. As shown in FIG. 3, a fueling nozzle FN is inserted into the fueling device 10 in a direction approximately parallel to a direction D1 along a center axis CX of the fueling device 10. The fuel ejected from the fueling nozzle FN flows in the fuel supply device 10 in the direction approximately parallel to the direction D1. The direction D1 is a direction parallel to the center axis CX to go from an end surface (open end surface) of the neck section 20 described later toward the joint section 25. In the description below, a front end side of the direction D1 is called “joint section side”, and a base end side of the direction D1 is called “open end surface side”. As illustrated in FIG. 3, the respective components constituting the fueling device 10 have approximately cylindrical appearance or approximately ring-shaped appearance and have their center axes that are substantially identical with the center axis CX of the fueling device 10. As illustrated in FIGS. 1 to 3, the pipe section 29 has cylindrical appearance and has one end connected with the neck section 20 and the other end connected with the joint section 25. The pipe section 29 has an outer diameter that is smaller than the outer diameter of the neck section 20 and the outer diameter of the joint section 25. The fuel supplied from the fueling nozzle FN flows through the inner bore of the pipe section 29. The fueling nozzle FN corresponds to the nozzle for fueling of the claims.

### A-2. Structure of Neck Section 20

As illustrated in FIG. 3, the neck section 20 is a resin member of cylindrical appearance and has an integral structure of a retainer mounting portion 23 and a pipe connecting portion 24.

As illustrated in FIG. 3, the retainer mounting portion 23 and the pipe connecting portion 24 are aligned in this sequence along the direction D1. More specifically, the retainer mounting portion 23 is placed on the open end surface side of the neck section 20, and the pipe connecting portion 24 is placed on the joint section side of the neck section 20.

As illustrated in FIGS. 2 and 3, the retainer mounting portion 23 has approximately cylindrical appearance and has the retainer 30 mounted to its open end surface side. As shown in FIG. 3, a through hole formed along the center axis CX in the retainer mounting portion 23 (and the retainer 30) is used as an insertion passage 12P of the fueling nozzle FN. The pipe connecting portion 24 has approximately cylindrical appearance and is connected with the retainer mounting portion 23 on the open end surface side and with the pipe section 29 on the joint section side. The pipe connecting portion 24 has an outer diameter that is smaller than the outer diameter of the retainer mounting portion 23. As illustrated in FIG. 3, the nozzle guide member 40 is mounted on the inner wall of the pipe connecting portion 24. The retainer mounting portion 23 corresponds to the neck end section of the claims.

From a different point of view from that of the above description, the structure of the neck section 20 may be regarded as a multi-layered structure as described below. More specifically, the neck section 20 has a multi-layered structure in which a first layer 11 on the inner diameter side and a second layer 12 on the outer diameter side are stacked in the radial direction as shown in FIGS. 2 and 3. The first layer 11 and the second layer 12 are both resin layers of cylindrical appearance. The outer circumferential surface of the first layer 11 is in contact with the inner circumferential surface of the second layer 12. This neck section 20 may be formed by, for example, two-color injection molding, two-layer extrusion molding or two-layer blow molding.

The first layer 11 is made of a first resin material, and the second layer 12 is made of a second resin material. The first resin material has the higher fuel resistance (higher fuel barrier property) as well as the higher compression strength and the higher bending strength than the second resin material. As shown in FIG. 3, the first layer 11 is located on the inner diameter side of the neck section 20 to be directly in contact with the fuel, so that the resin material having the higher fuel resistance (higher fuel barrier property) is employed for the first resin material according to the embodiment. The first layer 11 is in contact with the inner wall on the inner diameter side of the retainer 30, so that the resin material having the higher compression strength and the higher bending strength is employed for the first resin material, in order to enhance the dimensional accuracy and ensure that the retainer 30 is securely mounted on the neck section 20. Using the resin material having the higher compression strength and the higher bending strength as the first resin material suppresses deformation of the first layer 11 after manufacture and deformation of the retainer 30 accompanied with deformation of the first layer 11 and ensures that the fuel cap FC is securely attached to the fueling device 10. According to this embodiment, polyamide (PA) is employed for the first resin material. Available examples of the polyamide include nylon 6 and nylon 66.

The second resin material has the higher impact strength than the first resin material. According to this embodiment, the impact strength means strength specified by JIS (Japanese Industrial Standards) Izod impact test (JIS K7110:1999) (Izod impact strength). The material of the higher impact strength has the higher toughness and is unlikely to be broken or cracked. As described later, in the course of mounting the retainer 30 to the neck section 20, an end on the joint section side of the outer circumferential surface of the retainer 30 is caulked to cause plastic deformation of the second layer 12. The resin material of the higher impact strength (higher Izod impact strength) is used as the second resin material, in order to suppress the second layer 12 from being broken or cracked when the second layer 12 is subject to plastic deformation by such caulking. According to this embodiment, high-density polyethylene (HDPE) is employed for the second resin material.

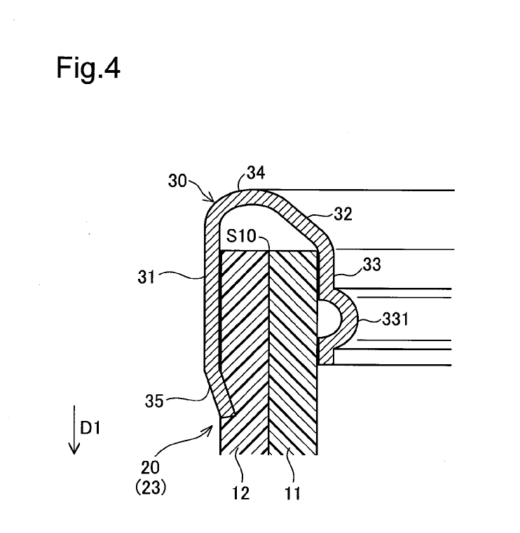

FIG. 4 is a diagram illustrating a cross section at an end on an open end surface side of the fueling device 10. FIG. 4 illustrates one cross section of the open end surface-side cross sections of the fueling device 10 along the center axis CX (i.e., two cross sections that are line-symmetric with respect to the center axis CX). As shown in FIG. 4, the end surface S10 on the open end surface side of the retainer mounting portion 23 corresponds to an end surface on the open end surface side of the neck section 20 and forms an open end of the neck section 20. Both the inner circumferential surface and the outer circumferential surface at an end on the open end surface side of the retainer mounting portion 23 are in contact with the inner wall of the retainer 30.

### A-3. Structure of Retainer 30

The retainer 30 is a ring-shaped metal member and is mounted over the outer circumferential surface of the neck section 20, the end surface S10 and the inner circumferential surface of the neck section 20 at an end on the open end surface side of the neck section 20 (retainer mounting portion 23). Mounting the retainer 30 to the neck section 20 in this manner enhances the sealing property between a gasket GS of the fuel cap FC and the fueling device 10, while improving the mechanical strength on the open end surface side of the neck section 20 (retainer mounting portion 23). The retainer 30 may be formed by, for example, press molding a thin plate of a metal material such as stainless steel.

As illustrated in FIGS. 2 to 4, the retainer 30 includes an outer circumferential protective portion 31, a linkage portion 34, a seal portion 32, an inner circumferential protective portion 33 and a caulked portion 35. The retainer 30 of FIG. 2 shows the retainer 30 prior to formation of the caulked portion 35.

As illustrated in FIG. 4, the retainer 30 has an approximately U-shaped cross section that is convex toward the open end surface side and is arranged to continuously surround the outer circumferential surface of the neck section 20 (retainer mounting portion 23), the end surface S10 of the neck section 20 (retainer mounting portion 23) and the inner circumferential surface of the neck section 20 (retainer mounting portion 23). As shown in FIGS. 2 and 3, the outer circumferential protective portion 31 has cylindrical appearance. As shown in FIGS. 3 and 4, an end on the joint section side of the outer circumferential protective portion 31 is connected with the caulked portion 35. The outer circumferential protective portion 31 is arranged to press the retainer mounting portion 23 radially inward (in the direction from the outer circumferential surface toward the center axis CX) and thereby suppress deformation of the retainer mounting portion 23 when the retainer mounting portion 23 absorbs the fuel to be swollen.

As illustrated in FIGS. 3 and 4, the appearance of the linkage portion 34 is ring-shaped appearance that is protruded in a direction opposite to the direction D1. An end on the outer circumferential side of the linkage portion 34 is connected with an end on the open end surface side of the outer circumferential protective portion 31. An end on the inner circumferential side of the linkage portion 34 is connected with an end on the open end surface side of the seal portion 32.

As illustrated in FIGS. 2 to 4, the appearance of the seal portion 32 is cone-shaped appearance having the inner circumferential diameter decreasing along the direction D1. When the fuel cap FC is attached to the fueling device 10, the gasket GS of the fuel cap FC comes into contact with the inner circumferential surface of the seal portion 32. This seals the insertion passage 12P against the outside. An end on the joint section side of the seal portion 32 is connected with an end on the open end surface side of the inner circumferential protective portion 33.

As illustrated in FIGS. 2 and 3, the appearance of the inner circumferential protective portion 33 is cylindrical appearance. As shown in FIG. 4, the inner wall of the inner circumferential protective portion 33 other than a threaded portion 331 described later is in contact with the inner circumferential surface of the retainer mounting portion 23, i.e., the inner circumferential surface of the first layer 11. The inner circumferential protective portion 33 is arranged to press the retainer mounting portion 23 (first layer 11) radially outward and thereby suppress deformation of the retainer mounting portion 23 when the retainer mounting portion 23 absorbs the fuel to be swollen. The inner circumferential protective portion 33 has a threaded portion 331 that is protruded radially inward. The threaded portion 331 is screwed to a threaded portion FCa of the fuel cap FC shown in FIG. 1 when the fuel cap FC is attached to the fueling device 10.

As illustrated in FIGS. 3 and 4, the caulked portion 35 is connected with the end on the joint section side of the outer circumferential protective portion 31 and is formed around the entire circumference to be placed radially inward toward the joint section side along the direction D1. In other words, the caulked portion 35 is arranged to be bent radially inward relative to the outer circumferential protective portion 31. The caulked portion 35 bites from the outer circumferential surface of the second layer 12 into the second layer 12. This “biting into the second layer 12” means that part on the joint section side of the caulked portion 35 is arranged radially inward relative to the outer circumferential surface of the second layer 12 in the state prior to formation of the caulked portion 35. The caulked portion 35 that is bent radially inward causes plastic deformation of the second layer 12 in the neighborhood of the caulked portion 35. Such plastic deformation of the second layer 12 suppresses the caulked portion 35 (retainer 30) from being moved in the direction D1 or in its opposite direction. The caulked portion 35 is formed by a manufacturing process of the fueling device 10 described later. The caulked portion 35 biting into the retainer mounting portion 23 (second layer 12), in other words, formation of the caulked portion 35 bent radially inward to cause plastic deformation of the second layer 12 enhances the joint performance between the retainer 30 and the neck section 20 and improves the sealing property between the retainer 30 and the neck section 20.

### A-4. Structure of Nozzle Guide Member 40

The nozzle guide member 40 is a cylindrical member provided to guide the fueling nozzle FN to the depth of the fueling device 10 and is engaged with and fit inside of the neck section 20 as shown in FIG. 3. As illustrated in FIGS. 2 and 3, the nozzle guide member 40 includes a guide body 42, a flange 43 formed at an end on the open end surface side of the guide body 42, and a guide tapered section 44 formed on the joint section side of the guide body 42, which are integrally formed by injection molding of a resin material such as polyacetal (POM). As shown in FIG. 2, the guide body 42 has two engagement claws 42a. These two engagement claws 42a engage with engaging claws (not shown) formed on the inner wall of the neck section 20 (pipe connecting portion 24). As shown in FIG. 2, the flange 43 has three engagement steps 43a arranged at predetermined intervals in the circumferential direction. Each of the engagement steps 43a is protruded radially outward and is fit on a step (not shown) formed on the inner wall on the joint section side of the retainer mounting portion 23. An end on the open end surface side of the guide tapered section 44 is connected with an end on the joint section side of the guide body 42. The inner diameter of the guide tapered section 44 decreases toward the joint section side along the direction D1. The inner diameter at a front end of the guide tapered section 44 is set to be slightly larger than the outer diameter of the fueling nozzle FN. As illustrated in FIG. 3, the through hole of the fueling device 10 along the center axis CX is divided by the guide tapered section 44 into a fuel passage 10P on the joint section side and an insertion passage 12P. According to another embodiment, the nozzle guide member 40 may be omitted from the fueling device 10.

### A-5. Manufacturing Process of Refueling Device 10

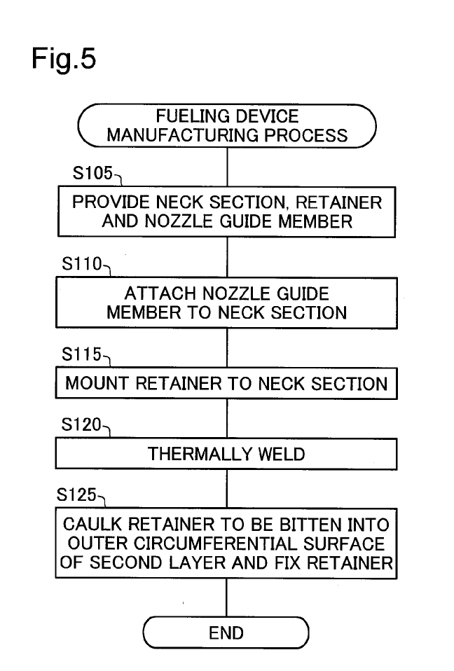

FIG. 5 is a flowchart showing a manufacturing process of the fueling device 10. The process first provides the neck section 20, the retainer 30 and the nozzle guide member 40 (step S105). As described above, the neck section 20 may be formed by two-color molding. For example, the two-color molding first injects the second resin material (HDPE) for formation of the second layer 12 and subsequently injects the first resin material (PA) for formation of the first layer 11. The neck section 20, the pipe section 29 and the joint section 25 may be formed integrally. In this application, the pipe section 29 and the joint section 25 are formed simultaneously with the neck section 20. The retainer 30 may be formed by press molding of a thin plate of a metal material. The nozzle guide member 40 may be formed by injection molding of a resin material.

The process subsequently attaches the nozzle guide member 40 to the neck section 20 (step S110) and mounts the retainer 30 at an end on the open end surface side of the neck section 20 (retainer mounting portion 23) (step S115). The retainer 30 mounted at step S115 is the retainer 30 in the state prior to formation of the caulked portion 35 as shown in FIG. 2. The process then heats the retainer 30 to thermally weld the retainer 30 to the neck section 20 (retainer mounting portion 23) (step S120). The retainer 30 may be heated by, for example, placing a heater outside (outer circumferential side) of the retainer 30 and supplying power to the heater. The retainer 30 is pressed in the direction D1, simultaneously with being heated. At this step S120, the outer circumferential surface at an end on the open end surface side of the second layer 12 is welded to the inner wall of the retainer 30 (outer circumferential protective portion 31) shown in FIG. 4. The inner circumferential surface at an end on the open end surface side of the first layer 11 is welded to the inner wall of the retainer 30 (inner circumferential protective portion 33). After the retainer 30 is heated for a predetermined time period, the power supply to the heater is stopped and the heater is removed, so that the respective resin materials are cooled down to be solidified.

The process subsequently caulks inward an end on the joint section side of the outer circumferential protective portion 31 to form the caulked portion 35 bent radially inward and cause plastic deformation of the second layer 12, so as to fix the retainer 30 to the neck section 20 (retainer mounting portion 23) (step S125). Such caulking may be performed by, for example, applying a pressure at the end on the joint section side of the outer circumferential protective portion 31 using a ring-shaped special jig. As described above, the second layer 12 is made of the second resin material having relatively high impact strength (high density polyethylene (HDPE) according to this embodiment). This suppresses the second layer 12 from being broken or cracked when the caulked portion 35 bites into the second layer 12 by such caulking (step S125) (i.e., causes plastic deformation of the second layer 12).

In the fueling device 10 of the first embodiment described above, the neck section 20 is made to have the multi-layered structure (two-layered structure) in the radial direction. The second layer 12 on the outer diameter side is made of the second resin material (high density polyethylene (HDPE)) having relatively high impact strength. This suppresses the second layer 12 from being broken or cracked in the course of formation of the caulked portion 35 of the retainer 30 and the resulting plastic deformation of the second layer 12 to fix the retainer 30 to the neck section 20. This allows the caulking technique to be employed to fix the retainer 30 to the neck section 20 and does not need large-scale equipment for manufacture of the fueling device 10. This accordingly suppresses an increase in manufacturing cost of the fueling device 10. Additionally, the caulked portion 35 biting into the second layer 12, in other words, plastic deformation of the second layer 12 enhances the joint performance between the retainer 30 and the neck section 20 and improves the sealing property between the retainer 30 and the neck section 20.

The first layer 11 on the inner diameter side of the neck section 20 is made of the first resin material (polyamide) having relatively high fuel resistance (relatively high fuel barrier property). This suppresses the neck section 20 from being deformed by absorption of the fuel and thereby improves the durability of the neck section 20. The first layer 11 is made of the first resin material (polyamide) having relatively high compression strength and relatively high bending strength. This enhances the dimensional accuracy on the inner diameter side of the neck section 20. This suppresses deformation of the neck section 20 from an expected shape to cause failure in mounting the retainer 30, as well as deformation of the retainer 30 accompanied with deformation of the neck section 20 to cause failure in attaching the fuel cap FC to the fueling device 10.

### B. Second Embodiment

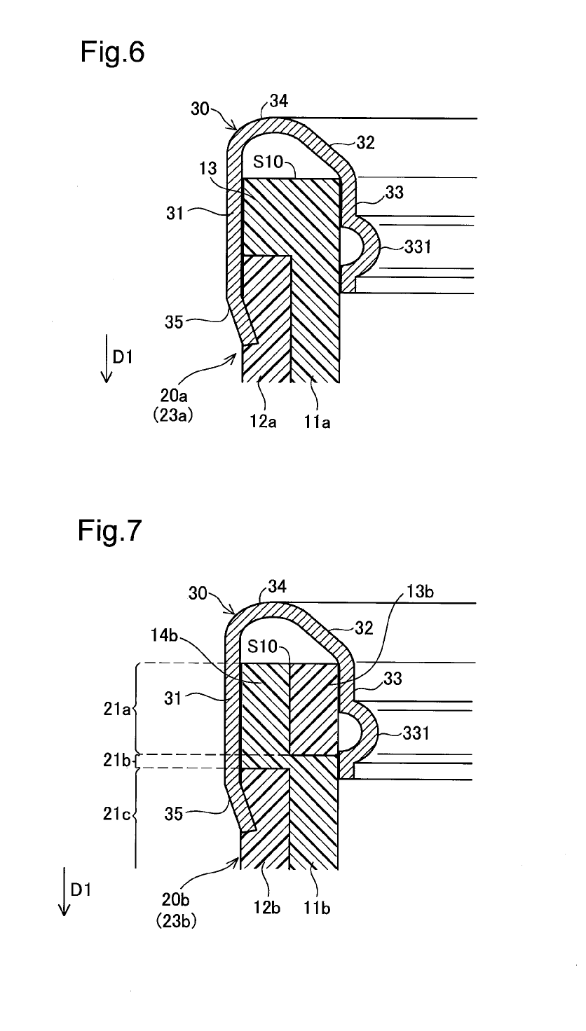

FIG. 6 is a cross sectional view illustrating a cross section at an end on an open end surface side in a fueling device according to a second embodiment. The fueling device of the second embodiment differs from the fueling device 10 of the first embodiment by providing a neck section 20a in place of the neck section 20. Otherwise the configuration of the fueling device of the second embodiment is similar to the configuration of the fueling device 10 of the first embodiment. The like components are expressed by the like numerals to those of the first embodiment and are not specifically described in detail here.

As shown in FIG. 6, the neck section 20a of the second embodiment differs from the neck section 20 of the first embodiment by providing a first layer 11a in place of the first layer 11, providing a second layer 12a in place of the second layer 12 and providing a retainer mounting portion 23a in place of the retainer mounting portion 23. Otherwise the structure of the neck section 20a of the second embodiment is similar to the structure of the neck section 20 of the first embodiment.

The first layer 11a of the second embodiment has an end on the open end surface side bent radially outward to form a flange part 13. As shown in FIG. 6, an end surface on the open end surface side of the flange part 13 corresponds to an end surface S10 of the neck section 20a. The outer circumferential surface of the flange part 13 is in contact with the inner wall of the retainer 30 (outer circumferential protective portion 31). The inner circumferential surface of the flange part 13 is in contact with the inner wall of the retainer 30 (inner circumferential protective portion 33).

The second layer 12a of the second embodiment differs from the second layer 12 of the first embodiment by that the second layer 12a has a shorter length along the direction D1 and that an end surface on the open end surface side of the second layer 12a is in contact with an end surface on the joint section side of the flange part 13. Otherwise the structure of the second layer 12a of the second embodiment is similar to the structure of the second layer 12 of the first embodiment. Accordingly, like the second layer 12 of the first embodiment, the caulked portion 35 of the retainer 30 bites from the outer circumferential surface into the second layer 12a. In other words, the caulked portion 35 bent radially inward is formed to cause plastic deformation of the second layer 12a.

The fueling device of the second embodiment having the above configuration has the similar advantageous effects to those of the fueling device 10 of the first embodiment. Additionally, in the fueling device of the second embodiment, the end on the open end surface side of the neck section 20a (flange part 13) is made of the first resin material, which is the same material as that of the first layer 11a. This flange part 13 is continuously formed over from the inner wall of the outer circumferential protective portion 31 of the retainer 30 to the inner wall of the inner circumferential protective portion 33 of the retainer 30. The first resin material has relatively high compression strength and relatively high bending strength and thereby enhances the dimensional accuracy of the flange part 13. Accordingly this further improves the mounting ability of the retainer 30 to the neck section 20a (retainer mounting portion 23a).

### C. Third Embodiment

FIG. 7 is a cross sectional view illustrating a cross section at an end on an open end surface side in a fueling device according to a third embodiment. The fueling device of the third embodiment differs from the fueling device 10 of the first embodiment by providing a neck section 20b in place of the neck section 20. Otherwise the configuration of the fueling device of the third embodiment is similar to the configuration of the fueling device 10 of the first embodiment. The like components are expressed by the like numerals to those of the first embodiment and are not specifically described in detail here.

As shown in FIG. 7, the neck section 20b of the third embodiment differs from the neck section 20 of the first embodiment by providing a first layer 11b in place of the first layer 11, providing a second layer 12b in place of the second layer 12, additionally providing a third layer 13b and a fourth layer 14b and providing a retainer mounting portion 23b in place of the retainer mounting portion 23. Otherwise the structure of the neck section 20b of the third embodiment is similar to the structure of the neck section 20 of the first embodiment.

The first layer 11b of the third embodiment has a shorter length along the direction D1 and has an end surface on the open end surface side that is in contact with an end surface on the joint section side of the third layer 13b. The outer circumferential surface at an end on the open end surface side of the first layer 11b is connected with the inner circumferential surface at an end on the joint section side of the fourth layer 14b. Otherwise the structure of the first layer 11b is similar to the structure of the first layer 11 of the first embodiment.

The second layer 12b of the third embodiment differs from the second layer 12 of the first embodiment by that the second layer 12b has a shorter length along the direction D1 and that an end surface on the open end surface side of the second layer 12b is in contact with an end surface on the joint section side of the fourth layer 14b. Otherwise the structure of the second layer 12b of the third embodiment is similar to the structure of the second layer 12 of the first embodiment. Accordingly, like the second layer 12 of the first embodiment, the caulked portion 35 of the retainer 30 bites from the outer circumferential surface into the second layer 12b. In other words, the caulked portion 35 bent radially inward is formed to cause plastic deformation of the second layer 12b.

The third layer 13b is placed on the inner diameter side of the fourth layer 14b and on the open end surface side of the first layer 11b. The inner circumferential surface of the third layer 13b is in contact with the inner wall of the retainer 30 (inner circumferential protective portion 33). The outer circumferential surface of the third layer 13b is in contact with the inner circumferential surface of the fourth layer 14b. An end surface on the joint section side of the third layer 13b is in contact with the end surface on the open end surface side of the first layer 11b. Like the second layer 12b, the third layer 13b is made of the second resin material.

The fourth layer 14b is placed on the outer diameter side of the third layer 13b and on the open end surface side of the second layer 12b. The inner circumferential surface of the fourth layer 14b is in contact with the outer circumferential surface of the third layer 13b on the open end surface side, while being in contact with the outer circumferential surface of the first layer 11b on the joint section side. The outer circumferential surface of the fourth layer 14b is in contact with the inner wall of the retainer 30 (outer circumferential protective portion 31). An end surface on the joint section side of the fourth layer 14b is in contact with the end surface on the open end surface side of the second layer 12b. An end surface on the open end surface side of the fourth layer 14b and an end surface on the open end surface side of the third layer 13b form an end surface S10 on the open end surface side of the neck section 20b.

The structure of the retainer mounting portion 23b is described from another point of view. The retainer mounting portion 23b has the structure including a first two-layered part 21a, a single-layered part 21b and a second two-layered part 21c, which are sequentially arranged along the direction D1. The first two-layered part 21a has an inner diameter side layer (the third layer 13b) made of the second resin material and an outer diameter side layer (open end surface side of the fourth layer 14b) made of the first resin material. The single-layered part 21b is made of the first resin material. The second two-layered part 21c has an inner diameter side layer (joint section side of the first layer 11b) made of the first resin material and an outer diameter side layer (the second layer 12b) made of the second resin material.

The fueling device of the third embodiment having the above configuration has the similar advantageous effects to those of the fueling device 10 of the first embodiment.

### D. Fourth Embodiment

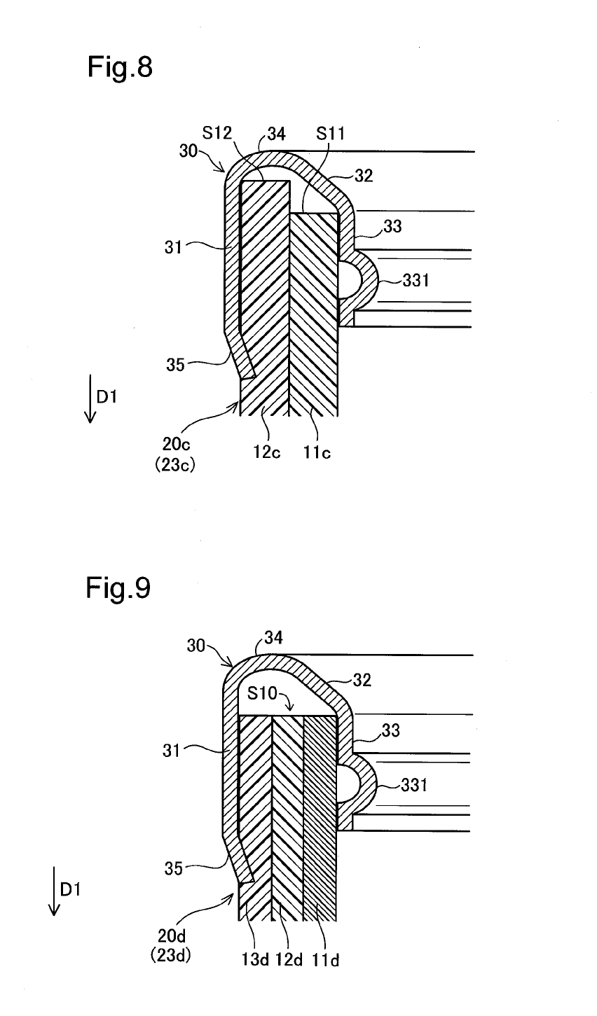

FIG. 8 is a cross sectional view illustrating a cross section at an end on an open end surface side in a fueling device according to a fourth embodiment. The fueling device of the fourth embodiment differs from the fueling device 10 of the first embodiment by providing a neck section 20c in place of the neck section 20. Otherwise the configuration of the fueling device of the fourth embodiment is similar to the configuration of the fueling device 10 of the first embodiment. The like components are expressed by the like numerals to those of the first embodiment and are not specifically described in detail here.

As shown in FIG. 8, the neck section 20c of the fourth embodiment differs from the neck section 20 of the first embodiment by providing a first layer 11c in place of the first layer 11 and providing a second layer 12c in place of the second layer 12. Otherwise the structure of the neck section 20c of the fourth embodiment is similar to the structure of the neck section 20 of the first embodiment. FIG. 8 illustrates the neighborhood of a retainer mounting portion 23c of the neck section 20c, like FIG. 4 of the first embodiment.

The first layer 11c of the fourth embodiment has the structure similar to the structure of the first layer 11 of the first embodiment shown in FIG. 4. Accordingly, the position along the center axis CX (direction D1) of an end surface S11 on the open end surface side of the first layer 11c of the fourth embodiment is equal to the position along the center axis CX (direction D1) of the end surface of the first layer 11 of the first embodiment (i.e., the end surface S10 of the neck section 20). The second layer 12c of the fourth embodiment, on the other hand, differs from the second layer 12 of the first embodiment by that the second layer 12c has the longer length along the direction D1. As shown in FIGS. 8 and 4, the position along the center axis CX (direction D1) of an end surface S12 on the open end surface side of the second layer 12c of the fourth embodiment is placed closer to the open end surface side than the position along the center axis CX (direction D1) of the end surface of the second layer 12 of the first embodiment (i.e., the end surface S10 of the neck section 20). Accordingly, an end surface on the open end surface side of the neck section 20c of the fourth embodiment has a stepped configuration of the two end surfaces S11 and S12 as shown in FIG. 8.

The following describes the reason why the second layer 12c is made to have the longer length along the direction D1 and the position along the center axis CX of the end surface S11 of the first layer 11c is placed closer to the joint section side than the position along the center axis CX of the end surface S12 of the second layer 12. At step S120 (thermally welding step) of FIG. 5, in the course of pressing-in of the retainer 30 in the direction D1, the second resin material (high density polyethylene (HDPE)) of the second layer 12c has relatively low rigidity and is more likely to be deformed by thermal fusion. The first resin material (polyamide (PA)) of the first layer 11c, on the other hand, has relatively high rigidity and is unlikely to be deformed by thermal fusion. The first layer 11c may thus work as a resistance in the course of pressing-in of the retainer 30 in the direction D1. According to the fourth embodiment, the first layer 11c is made to have the relatively shorter length along the direction D1, and the position along the center axis CX (direction D1) of the end surface S11 of the first layer 11c is placed closer to the joint section side than the position along the center axis CX (direction D1) of the end surface S12 of the second layer 12c. This structure facilitates pressing-in of the retainer 30 in the direction D1 and thereby improves the joint performance between the retainer 30 and the neck section 20c.

The fueling device of the fourth embodiment having the above configuration has the similar advantageous effects to those of the fueling device 10 of the first embodiment. Additionally, in the fueling device of the fourth embodiment, the first layer 11c is made to have the relatively shorter length along the direction D1, and the position along the center axis CX (direction D1) of the end surface S11 of the first layer 11c is placed closer to the joint section side than the position along the center axis CX (direction D1) of the end surface S12 of the second layer 12c. This structure facilitates pressing-in of the retainer 30 in the direction D1 at step S120 and thereby improves the joint performance between the retainer 30 and the neck section 20c.

### E. Fifth Embodiment

FIG. 9 is a cross sectional view illustrating a cross section at an end on an open end surface side in a fueling device according to a fifth embodiment. The fueling device of the fifth embodiment differs from the fueling device 10 of the first embodiment by providing a neck section 20d in place of the neck section 20. Otherwise the configuration of the fueling device of the fifth embodiment is similar to the configuration of the fueling device 10 of the first embodiment. The like components are expressed by the like numerals to those of the first embodiment and are not specifically described in detail here.

As shown in FIG. 9, the neck section 20d of the fifth embodiment differs from the neck section 20 of the first embodiment by that the neck section 20d has a three-layered structure in the radial direction. Otherwise the structure of the neck section 20d of the fifth embodiment is similar to the structure of the neck section 20 of the first embodiment. FIG. 9 illustrates the neighborhood of a retainer mounting portion 23d of the neck section 20d, like FIG. 4 of the first embodiment.

As shown in FIG. 9, the neck section 90d has a first layer 11d, a second layer 12d and a third layer 13d. The first layer 11d is a layer placed on the innermost diameter side and is made of a third resin material. The third resin material is different from the first resin material and the second resin material and is a resin material having electrical conductivity according to this embodiment. A material obtained by adding carbon to the second resin material (high density polyethylene (HDPE)) is used as the resin material having electrical conductivity according to the embodiment. The second layer 12d is made of the first resin material (polyamide (PA)) of the first embodiment. The third layer 13d is made of the second resin material (high density polyethylene (HDPE)) of the first embodiment. This neck section 20d may be formed by, for example, three-color extrusion molding.

In the state that the fueling device of the fifth embodiment is mounted on a vehicle, the first layer 11d is in contact with a metal fitting (not shown) inserted radially inward from the outer circumferential surface (third layer 13d) at the pipe section 29 shown in FIGS. 1 to 3. A grounding pathway to a vehicle body member (for example, side member) is formed via the first layer 11d, the metal fitting and a bolt (not shown). The first layer 11d has electrical conductivity and accordingly enables the static electricity accumulated on the user to be released to the vehicle body member through the retainer 30 and the first layer 11d.

The fueling device of the fifth embodiment having the above configuration has the similar advantageous effects to those of the fueling device 10 of the first embodiment. Additionally, the first layer 11d placed on the innermost diameter side is made of the resin material having electrical conductivity and thus enables the static electricity accumulated on the user to be released through the first layer 11d to the vehicle body member. While the innermost diameter layer is made of the first resin material, the middle layer (second layer 12d) is made of the second resin material, which enhances the dimensional accuracy of the neck section 20d.

### F. Sixth Embodiment

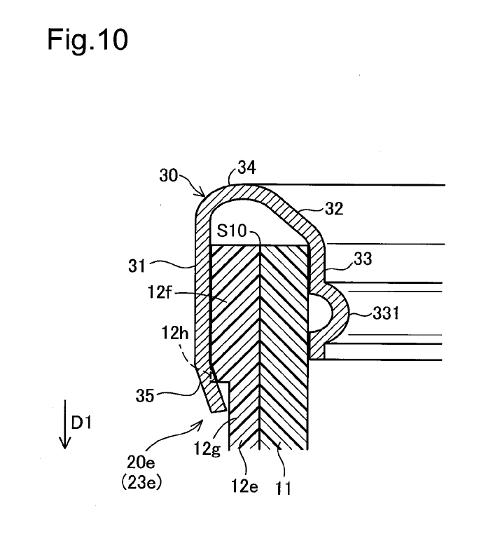

FIG. 10 is a cross sectional view illustrating a cross section at an end on an open end surface side in a fueling device according to a sixth embodiment. The fueling device of the sixth embodiment differs from the fueling device 10 of the first embodiment by providing a neck section 20e in place of the neck section 20. Otherwise the configuration of the fueling device of the sixth embodiment is similar to the configuration of the fueling device 10 of the first embodiment. The like components are expressed by the like numerals to those of the first embodiment and are not specifically described in detail here.

As shown in FIG. 10, the neck section 20e of the sixth embodiment differs from the neck section 20 of the first embodiment by that the neck section 20e has a second layer 12e in place of the second layer 12 and that a part of the caulked portion 35 in contact with the second layer 12e is an end on the open end surface side of the caulked portion 35. Otherwise the structure of the neck section 20e of the sixth embodiment is similar to the structure of the neck section 20 of the first embodiment. FIG. 10 illustrates the neighborhood of a retainer mounting portion 23e of the neck section 20e, like FIG. 4 of the first embodiment.

The second layer 12e of the sixth embodiment has a large diameter part 12f that is located at an end on the open end surface side and a small diameter part 12g that is located on the joint section side relative to the large diameter part 12f and is in contact with the large diameter part 12f. The large diameter part 12f has an outer diameter that is greater than the outer diameter of the small diameter part 12g. The large diameter part 12f has an inner diameter that is equal to the inner diameter of the small diameter part 12g.

As illustrated in FIG. 10, the caulked portion 35 of the sixth embodiment is bent radially inward, like the caulked portion 35 of the first embodiment. The caulked portion 35 of the sixth embodiment bent radially inward like the caulked portion 35 of the first embodiment causes an end on the joint section side of the large diameter part 12f to cause plastic deformation. Such plastic deformation of the large diameter part 12f suppresses the caulked portion 35 (retainer 30) from moving in the direction D1 or in its opposite direction.

According to the first embodiment, the part of the caulked portion 35 biting into the second layer 12 (coming into contact with the second layer 12) is its end on the joint section side. According to the sixth embodiment, on the other hand, the part of the caulked portion 35 biting into the large diameter part 12f is its end on the open end surface side. This “biting into the large diameter part 12f” means that part on the open end surface side of the caulked portion 35 is arranged radially inward relative to an outer circumferential surface 12h at an end on the joint section side of the large diameter part 12f in the state prior to formation of the caulked portion 35.

The fueling device of the sixth embodiment having the above configuration has the similar advantageous effects to those of the fueling device 10 of the first embodiment.

### G. Seventh Embodiment

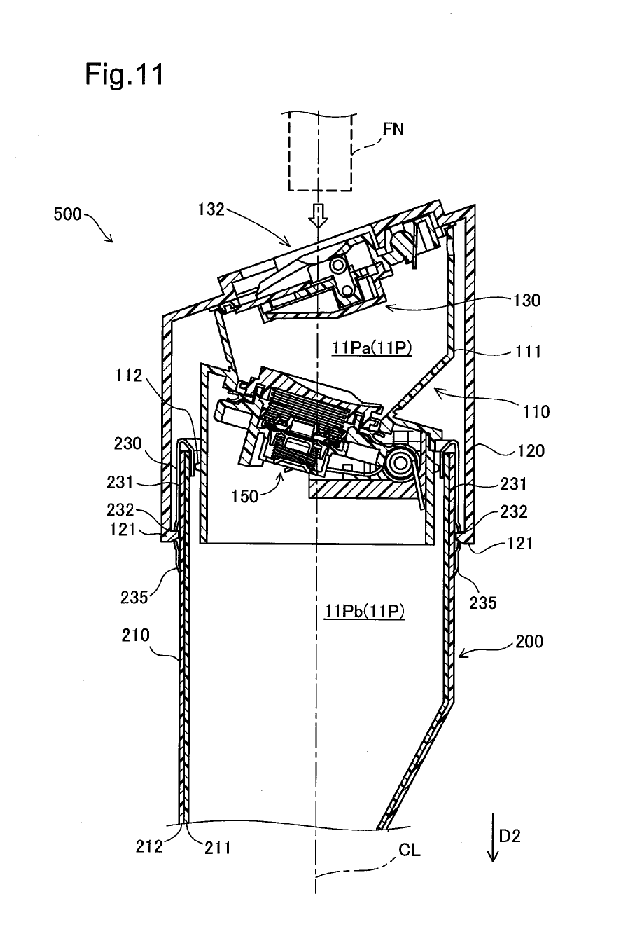

FIG. 11 is a cross sectional view illustrating the schematic configuration of an open-close device 500, which a fueling device 200 of a seventh embodiment is applied to. The open-close device 500 has a mechanism configured to supply fuel to a fuel tank (not shown) without using a fuel cap. The open-close device 500 is operative to open and close a fuel passage 11P from a filler port 132 described later to the fuel tank (not shown). In the case of fueling using the open-close device 500, the user inserts an end of a fueling nozzle FN into the open-close device to press open a valve mechanism and supply fuel to the fuel tank through the filler port 132 accessible by valve-opening. In the state of FIG. 11, the fueling nozzle FN has not yet been inserted into the open-close device 500, and the filler port 132 is closed. In the description below, a direction going from the filler port 132 toward the fueling device 200 (in other words, direction going from the filler port 132 toward a joint section (not shown)) along a center axis CL of the open-close device 500 is called “direction D2”. A front end side of the direction D2 is called “joint section side”, and a base end side of the direction D2 is called “open end surface side”.

The open-close device 500 includes the fueling device 200, a valve mechanism 110 and a cover member 120. The fueling device 200 has a neck section 210 and a retainer 230. The open-close device 500 also has a pipe section and a joint section (neither shown) on the joint section side relative to the neck section 210. The pipe section (not shown) has one end connected with an end on the joint section side of the neck section 210 and the other end connected with the joint section (not shown). The pipe section and the joint section (neither shown) included in the open-close device 500 have the similar functions to those of the pipe section 29 and the joint section 25 of the respective embodiments described above.

The neck section 210 has approximately cylindrical appearance and has a two-layered structure like the neck section 20 of the first embodiment. More specifically, the neck section 210 has a first layer 211 of approximately cylindrical shape located on the inner diameter side and a second layer 212 of approximately cylindrical shape located on the outer diameter side, which are stacked in the radial direction and a joined with each other. The first layer 211 is made of the first resin material (polyamide (PA)), like the first layer 11 of the first embodiment. The second layer 212 is made of the second resin material (high density polyethylene (HDPE)), like the second layer 12 of the first embodiment.

The retainer 230 differs from the retainer 30 of the first embodiment by that an outer circumferential protective portion 231 is extended along the direction D2 on the joint section side and that the outer circumferential protective portion 231 has locking apertures 232 on its joint section side. Otherwise, the structure of the retainer 230 is similar to the structure of the retainer 30 of the first embodiment. A plurality of the locking apertures 232 are provided along the circumferential direction in the neighborhood of the end on the joint section side of the outer circumferential protective portion 231. A most joint section side-edge of the outer circumferential protective portion 231 forms a caulked portion 235, which bites into the second layer 212. In other words, the caulked portion 235 bent radially inward is formed to cause plastic deformation of the second layer 212.

The valve mechanism 110 includes a passage-forming member 111, a first flap valve mechanism 130 and a second flap valve mechanism 150. The passage-forming member 111 divides the fuel passage 11P into a filler port side pathway 11Pa on the filler port 132-side and a tank side pathway 11Pb on the fuel tank side. The passage-forming member 111 has bent cylindrical appearance having openings at both an end surface on the joint section side and an end surface on the open end surface side. A threaded portion 112 is formed on the outer circumferential surface on the joint section side of the passage-forming member 111. The threaded portion 112 is screwed to a threaded portion of the retainer 230 (corresponding to the threaded portion 331 of the first embodiment).

The first flap valve mechanism 130 is located at an end on the open end surface side of the passage-forming member 111 and is operative to open and close the filler port 132 in response to insertion and withdrawal of the fueling nozzle FN. More specifically, when the fueling nozzle FN is inserted along the direction D2 into the open-close device 500, the first flap valve mechanism 130 is rotated in the direction D2. When the inserted fueling nozzle FN is withdrawn, the first flap valve mechanism 130 is rotated in the direction opposite to the direction D2 to close the filler port 132. The first flap valve mechanism 130 having this structure serves as a shielding member to prevent the second flap valve mechanism 150 from being exposed to rainwater, dust, sand and the like.

The second flap valve mechanism 150 is located on the joint section side of the passage-forming member 111 and is rotated in the direction D2 when the fueling nozzle FN is inserted along the direction D2 into the open-close device 500, like the first flap valve mechanism 130. The second flap valve mechanism 150 is also rotated in the direction opposite to the direction D2 when the inserted fueling nozzle FN is withdrawn. The second flap valve mechanism 150 has a pressure regulator which serves to regulate the internal pressure of the fuel tank to a specified range.

The cover member 120 has approximately cylindrical appearance having an inner diameter and an outer diameter that are respectively greater than the inner diameter and the outer diameter of the fueling device 200. Locking elements 121 protruded radially inward are formed at an end on the joint section side of the cover member 120. In the open-close device 500, engagement of the locking elements 121 with the locking apertures 232 of the fueling device 200 suppresses the cover member 120 from being unintentionally detached from the fueling device 200. The cover member 120 has an opening at an end on the open end surface side, so that the first flap valve mechanism 130 described above is exposed on this opening.

The fueling device 200 having the above configuration has the similar advantageous effects to those of the fueling device 10 of the first embodiment described above. More specifically, the neck section 210 has the multi-layered structure (two-layered structure), and the second layer 212 on the outer diameter side is made of the second resin material (high density polyethylene (HDPE)) having relatively high impact strength. This suppresses the second layer 212 from being broken or cracked when the caulked portion 235 of the retainer 230 bites from the outer circumferential surface into the second layer 212 (i.e., causes plastic deformation of the second layer 212) in order to fix the retainer 230 to the neck section 210. This allows the caulking technique to be employed to fix the retainer 230 to the neck section 210 and does not need large-scale equipment for manufacture. This accordingly suppresses an increase in manufacturing cost of the fueling device 200 (and thereby the open-close device 500). Additionally, the caulked portion 235 biting into the second layer 212 (in other words, plastic deformation of the second layer 212) enhances the joint performance between the retainer 230 and the neck section 210 and improves the sealing property between the retainer 230 and the neck section 210.

The first layer 211 on the inner diameter side of the neck section 210 is made of the first resin material (polyamide (PA)) having relatively high fuel resistance (relatively high fuel barrier property). This suppresses the neck section 210 from being deformed by absorption of the fuel and thereby improves the durability of the neck section 210. The first layer 211 is made of the first resin material (polyamide (PA)) having relatively high compression strength and relatively high bending strength. This enhances the dimensional accuracy on the inner diameter side of the neck section 210. This suppresses deformation of the neck section 210 from an expected shape to cause failure in mounting the retainer 230, as well as failure in mounting the valve mechanism 110 to the fueling device 200. The structure of any of the neck sections 20a to 20d of the second to the fifth embodiments described above may be applied to the fueling device 200 of the seventh embodiment.

### H. Modifications

### H1. Modification 1

The neck section 20 of the first embodiment, the neck section 20c of the fourth embodiment, the neck section 20e of the sixth embodiment and the neck section 210 of the seventh embodiment have the two-layered structures in the radial direction. The neck section 20d of the fifth embodiment has the three-layered structure in the radial direction. As clearly understood from these embodiments, the neck section in the fueling device of the invention may have a multi-layered structure including any number of layers in the radial direction. In each of these embodiments, a layer on the outermost diameter side is made of the second resin material. The invention is, however, not limited to this structure. For example, the layer on the outermost diameter side may be made of the third resin material, and a second outermost diameter layer on the inner side of the outermost diameter layer may be made of the second resin material. In this application, it is preferable that the layer made of the second resin material is located on the outer side of the layer made of the first resin material. In this structure, the caulked portion 35 or 235 is preferably arranged to bite from the surface of the layer made of the second resin material (second outermost diameter layer) into this second outermost diameter layer (in other words, to be bent radially inward and cause plastic deformation of the second outermost diameter layer). It is more preferable that the layer on the outermost diameter side is made of the second resin material. As understood from the description on the neck section 20a of the second embodiment and the description on the neck section 20b of the third embodiment, it is preferable that the neck section having the multi-layered structure in at least a region corresponding to the caulked portion 35 or 235 of the retainer 30 or 230 in the radial direction is applied to the fueling device of the invention. In general, it is accordingly preferable that a neck section having a cylindrical first layer made of the first resin material and a cylindrical second layer made of the second resin material and located on the outer diameter side of the first layer is applied to the fueling device of the invention.

### H2. Modification 2

In the respective embodiments described above, the caulked portion 35 or 235 achieves the sealing property between the retainer 30 or 230 and the neck section 20, 20a, 20b, 20c, 20d, 20e or 210. In addition to the caulked portion 35 or 235, a sealing member may be provided to achieve the sealing property. More specifically, for example, the sealing member may be placed between the inner wall of the outer circumferential protective portion 31 and the outer circumferential surface of the second layer 12. The sealing member may be, for example, an O-ring or a member having partially missing ring-shaped (C-shaped) appearance or arc-shaped appearance. The material of this sealing member may be made of any elastically deformable material, for example, nitrile butadiene rubber (NBR). In the application using the sealing member, step S120 (thermally welding step) of FIG. 5 may be omitted.

### H3. Modification 3

In the seventh embodiment described above, the valve mechanism 110 includes the two flap valve mechanisms 130 and 150. Alternatively the valve mechanism 110 may have only one flap valve mechanism. For example, the cover member 120, the passage-forming member 111 and the first flap valve mechanism 130 may be omitted from the open-close device 500 of the seventh embodiment. In this modified configuration, a cylindrical member may be provided to support the second flap valve mechanism 150 in the circumferential direction, and a threaded portion may be formed on the outer circumferential surface of this cylindrical member such as to be screwed to an open part of the retainer 230.

### H4. Modification 4

In the respective embodiments described above, the fueling device 10 or 200 is directly connected to the fuel tank FT. The invention is, however, not limited to this configuration. According to another embodiment, the fueling device 10 or 200 may be connected to the fuel tank FT via one or a plurality of joints or via one or a plurality of pipes. In such modified configurations, the joint or the pipe connecting with the fuel tank FT corresponds to the joint section of the claims. In these modified configurations, the fueling device 10 or 200 and the joint or the pipe placed between the fueling device 10 or 200 and the fuel tank FT correspond to the fueling device of the claims.

### H5. Modification 5

In the respective embodiments described above, polyamide (PA) is employed for the first resin material of the first layer 11. The polyamide may, however, be replaced by any resin material having high fuel resistance (high fuel barrier property) as well as high compression strength and high bending strength, such as ethylene vinyl alcohol copolymer (EVOH). The high density polyethylene (HDPE) is employed for the second resin material of the second layer 12. The high density polyethylene may, however, be replaced by any other polyethylene, such as low density polyethylene (LDPE) or a resin material having modified maleic acid as the polar functional group (modified polyethylene). The modified polyethylene is joined with polyamide (PA) by chemical bonding. This enhances the joint performance between the first layer 11 and the second layer 12.

### H6. Modification 6

In the respective embodiments described above, the caulked portion 35 or 235 is located at the end on the joint section side of the retainer 30 or 230. The invention is, however, not limited to this configuration. For example, the caulked portion 35 or 235 may be provided at any position between the end on the open end surface side and the end on the joint section side on the outer circumferential surface of the retainer 30 or 230. In the respective embodiments, the caulked portion 35 or 235 is formed around the entire circumference. The caulked portion 35 or 235 may alternatively be formed along only part of the entire circumference, instead of around the entire circumference. This modified configuration of forming the caulked portion 35 or 235 along only part of the entire circumference may be employed in the configuration of providing the caulked portion 35 or 235 at any position between the end on the open end surface side and the end on the joint section side described above.

The invention is not limited to any of the embodiments and the modifications described herein but may be implemented by a diversity of other configurations without departing from the scope of the invention. For example, the technical features of the embodiments, examples or modifications corresponding to the technical features of the respective aspects described in Summary may be replaced or combined appropriately, in order to solve part or all of the problems described above or in order to achieve part or all of the advantageous effects described above. Any of the technical features may be omitted appropriately unless the technical feature is described as essential herein. For example, the invention may be implemented by any of the following aspects.

According to one aspect of the invention, there is provided a fueling device that a fueling nozzle is inserted in and that supplies fuel ejected from the fueling nozzle into a fuel tank. This fueling device comprises: a joint section provided to be connected with the fuel tank; a neck section that includes a cylindrical appearance and a multi-layered structure in a radial direction; and a retainer that includes a caulked portion; wherein the neck section further includes: a neck end portion that includes an open end surface forming an open end of the neck section; a first layer of cylindrical appearance made of a first resin material; and a second layer of cylindrical appearance located on an outer diameter side of the first layer and made of a second resin material having higher impact strength than impact strength of the first resin material, the neck end portion is extended from the open end surface along a fuel supply direction from the open end surface toward the joint section that is parallel to a center axis of the neck section, the retainer is attached to the neck section such as to continuously surround at least part of an outer circumferential surface of the neck section, the open end surface and at least part of an inner circumferential surface of the neck section, and the caulked portion is bent radially inward to cause plastic deformation of the second layer. In the fueling device of this aspect, the neck section has the multi-layered structure in the radial direction, and the second layer on the outer diameter side is made of the second resin material having the higher impact strength. This suppresses the second layer from being broken or cracked when the caulked portion is bent radially inward to cause plastic deformation of the second layer. This allows, for example, the caulking technique to be employed to fix the retainer to the neck section and does not need any special equipment or large-scale equipment for manufacture of the fueling device. This accordingly suppresses an increase in manufacturing cost of the fueling device. Additionally, the caulked portion bent radially inward to cause plastic deformation of the second layer enhances the joint performance between the retainer and the neck section and improves the sealing property between the retainer and the neck section.

In the fueling device of the above aspect, the neck section comprises a two-layered structure including the first layer and the second layer, the first layer is located on an inner diameter side at any region along the fuel supply direction, and the second layer is located on an outer diameter side at any region along the fuel supply direction. In the fueling device of this aspect, the neck section may be readily formed by two-color injection molding.

In the fueling device of the above aspect, the first resin material is polyamide (PA), and the second resin material is polyethylene (PE). In the fueling device of this aspect, the first layer located on the inner diameter side is made of polyamide (PA) having relatively high fuel resistance (relatively high fuel barrier property). This suppresses the neck section from being deformed by absorption of the fuel and thereby improves the durability of the neck section. The first layer is made of polyamide (PA) having relatively high compression strength and relatively high bending strength (i.e., relatively high rigidity). This enhances the dimensional accuracy on the inner diameter side of the neck section. This suppresses deformation of the neck section from an expected shape to cause failure in mounting the retainer. This also suppresses deformation of the retainer accompanied with deformation of the neck section in the course of attachment of, for example, a fuel cap or a valve element to the retainer to cause failure in attaching the fuel cap or the valve element to the fueling device. The second layer located on the outer diameter side is made of polyethylene (PE) having relatively high impact strength. This suppresses the second layer from being broken or cracked when the caulked portion is bent radially inward to cause plastic deformation of the second layer.

According to another aspect of the invention, there is provided a manufacturing method of a fueling device that a fueling nozzle is inserted in, that supplies fuel ejected from the refueling nozzle into a fuel tank and that includes a joint section provided to be connected with the fuel tank. This manufacturing method comprising the steps of: providing a neck section that includes a cylindrical appearance, a multi-layered structure in a radial direction, a neck end portion that includes an open end surface forming an open end of the neck section, a first layer of cylindrical appearance made of a first resin material and a second layer of cylindrical appearance located on an outer diameter side of the first layer and made of a second resin material having higher impact strength than impact strength of the first resin material; attaching a retainer to the neck section such that the retainer continuously surrounds at least part of an outer circumferential surface of the neck section, the open end surface and at least part of an inner circumferential surface of the neck section; and caulking radially inward at least part of an outer circumferential surface of the retainer to form a caulked portion bent radially inward to cause plastic deformation of the second layer, so as to fix the retainer to the neck section, wherein the neck end portion is extended from the open end surface along a fuel supply direction from the open end surface toward the joint section which is parallel to a center axis of the neck section. In the manufacturing method of the fueling device of this aspect, the neck section has the multi-layered structure in the radial direction, and the second layer on the outer diameter side is made of the second resin material having the higher impact strength. This suppresses the second layer from being broken or cracked when the caulked portion is bent radially inward to cause plastic deformation of the second layer in the step (c). The manufacturing method of this aspect employs the caulking technique to fix the retainer to the neck section while suppressing damage of the neck section. This does not need any special equipment or large-scale equipment for manufacture of the fueling device. This accordingly suppresses an increase in manufacturing cost of the fueling device. Additionally, the caulked portion bent radially inward to cause plastic deformation of the second layer enhances the joint performance between the retainer and the neck section and improves the sealing property between the retainer and the neck section.

1. A fueling device that a fueling nozzle is inserted in and that supplies fuel ejected from the fueling nozzle into a fuel tank, comprising:
a joint section provided to be connected with the fuel tank;
a neck section that includes a cylindrical appearance and a multi-layered structure in a radial direction; and
a retainer that includes a caulked portion; wherein
the neck section further includes:
a neck end portion that includes an open end surface forming an open end of the neck section;
a first layer of cylindrical appearance made of a first resin material; and
a second layer of cylindrical appearance located on an outer diameter side of the first layer and made of a second resin material having higher impact strength than impact strength of the first resin material,
the neck end portion is extended from the open end surface along a fuel supply direction from the open end surface toward the joint section that is parallel to a center axis of the neck section,
the retainer is attached to the neck section such as to continuously surround at least part of an outer circumferential surface of the neck section, the open end surface and at least part of an inner circumferential surface of the neck section, and
the caulked portion is bent radially inward to cause plastic deformation of the second layer.

2. The fueling device according to claim 1, wherein
the neck section comprises a two-layered structure including the first layer and the second layer,
the first layer is located on an inner diameter side at any region along the fuel supply direction, and
the second layer is located on an outer diameter side at any region along the fuel supply direction.

3. The fueling device according to claim 1, wherein
the first resin material is polyamide (PA), and
the second resin material is polyethylene (PE).

4. The fueling device according to claim 2, wherein
the first resin material is polyamide (PA), and
the second resin material is polyethylene (PE).

5. The fueling device according to claim 1, wherein
a cross sectional shape of the retainer parallel to the center axis is U shape convex in a direction opposite to the fuel supply direction.

6. The fueling device according to claim 5, wherein
the retainer further includes:
an inner circumferential protective portion that is in contact with an inner circumferential surface of the neck section; and
a seal portion that is connected with an end in a direction opposite to the fuel supply direction of the inner circumferential protective portion, and
the seal portion has cone-shaped appearance with an inner circumferential diameter decreasing along the fuel supply direction.

7. The fueling device according to claim 5, wherein
the retainer further includes:
an inner circumferential protective portion that is in contact with an inner circumferential surface of the neck section; and
a threaded portion formed on the inner circumferential protective portion to be protruded radially inward.

8. The fueling device according to claim 5, further comprising:
a fuel cap includes a threaded portion, wherein
the threaded portion of the fuel cap is screwed to the threaded portion formed on an inner circumferential surface of the retainer.

9. The fueling device according to claim 1, wherein
the retainer further includes:
an outer circumferential protective portion that is in contact with an outer circumferential surface of the neck section; and
a locking aperture formed to be open in an outer circumferential surface of the outer circumferential protective portion and configured to engage with a locking element of a cover member that covers at least part of the retainer.

10. An open-close device, comprising:
the fueling device according to claim 1; and
a valve mechanism that includes a flap valve provided to open and close a fuel passage formed inside of the fueling device and arranged to be in contact with the retainer and thereby to be supported.

11. A manufacturing method of a fueling device that a fueling nozzle is inserted in, that supplies fuel ejected from the fueling nozzle into a fuel tank and that includes a joint section provided to be connected with the fuel tank, the manufacturing method comprising the steps of:
providing a neck section that includes a cylindrical appearance, a multi-layered structure in a radial direction, a neck end portion that includes an open end surface forming an open end of the neck section, a first layer of cylindrical appearance made of a first resin material and a second layer of cylindrical appearance located on an outer diameter side of the first layer and made of a second resin material having higher impact strength than impact strength of the first resin material;
attaching a retainer to the neck section such that the retainer continuously surrounds at least part of an outer circumferential surface of the neck section, the open end surface and at least part of an inner circumferential surface of the neck section; and
caulking radially inward at least part of an outer circumferential surface of the retainer to form a caulked portion bent radially inward to cause plastic deformation of the second layer, so as to fix the retainer to the neck section, wherein
the neck end portion is extended from the open end surface along a fuel supply direction from the open end surface toward the joint section which is parallel to a center axis of the neck section.
